(19) United States
(12) Patent Application Publication
(10) Pub. No.: US 2026/0133923 A1
(43) Pub. Date: May 14, 2026

(54) SPLIT DMA CONTROLLER THAT EMPLOYS VIRTUAL CHANNELS

(71) Applicant: TEXAS INSTRUMENTS INCORPORATED, Dallas, TX (US)

(72) Inventors: David Smith, Allen, TX (US); Vignesh Raghavendra, Bangalore (IN); Chunhua Hu, Plano, TX (US)

(21) Appl. No.: 19/255,326

(22) Filed: Jun. 30, 2025

Related U.S. Application Data
(60) Provisional application No. 63/718,196, filed on Nov. 8, 2024.

(51) Int. Cl. G06F 13/28

(52) U.S. Cl. CPC G06F 13/28; G06F 2213/28

(57) ABSTRACT

Various embodiments of the present disclosure relate to handling traffic in a split DMA controller having primary channel circuits, secondary channel circuits, a packet switch, and a state machine. In one example embodiment, a technique for routing data via the state machine is provided. The technique first includes receiving a request to transmit data via a primary channel circuit to a device associated with a secondary channel circuit. Next, the technique includes determining that the secondary channel circuit is available and responsively pairing the primary channel circuit with the secondary channel circuit. The technique then includes enabling a virtual channel that is associated with the device and the secondary channel circuit. Finally, the technique includes instructing the primary channel circuit to transmit the data via the packet switch to the secondary channel circuit and causing the secondary channel circuit to write the data to the device using the virtual channel.

### CROSS-REFERENCE TO RELATED APPLICATION

This application is related to, and claims the benefit of priority to, U.S. Provisional Patent Application No 63/718,196, filed on Nov. 8^{th}, 2024, and entitled “SHARED LOW LATENCY DMA CHANNEL”, which is hereby incorporated by reference in its entirety.

### TECHNICAL FIELD

Aspects of the disclosure are related to direct memory access (DMA) controllers, and in particular, to handling traffic within the context of a split DMA architecture.

### BACKGROUND

Direct memory access (DMA) controllers are devices that are commonly utilized within computing systems to offload data-transfer operations from the central processing unit (CPU) of the associated system. For example, in a system where a DMA controller is coupled to multiple memories and multiple peripherals, the CPU of the system may request the DMA controller to transfer data from a memory to a peripheral, from a peripheral to a memory, between peripherals, or between memories. More generally, the CPU of the system may request the DMA controller to transfer data from a high-latency, or low-latency source, to a high-latency, or low-latency destination. However, conventional DMA controllers are often designed to manage large data transfer operations, and as a result, may tolerate higher latency and may be better suited for systems that integrate high-latency devices.

In contrast, a split DMA controller is a device that is designed to efficiently manage both large and small data transfer operations, making it well suited for systems that include both high-and low-latency devices. The standard split DMA controller includes a primary DMA portion that interfaces with a high-latency memory, as well as a secondary DMA portion that interfaces with various low-latency peripherals. For example, the primary DMA portion may transfer data to and from an external memory, such as flash memory, while the secondary DMA portion transfers data to and from various low-latency peripherals, such as input/output (I/O) devices, sensors, communication devices, or another peripheral of the like.

Typically, the primary DMA portion and the secondary DMA portion of a split DMA controller each include multiple DMA channels for interfacing with respective devices. For example, the primary DMA portion may include a set of high-latency DMA channels that interface with a high-latency memory, while the secondary DMA portion includes a set of low-latency DMA channels that interface with various low-latency peripherals. Problematically, not all the peripherals are active at the same time. As a result, dedicating a low-latency DMA channel to each peripheral can lead to inefficient use of system resources. For example, the incorporation of dedicated low-latency DMA channels may increase the system cost, complexity, and power consumption, while reducing the available area. These drawbacks are particularly significant in the context of low-cost, low-power systems, where minimizing area, cost, and energy usage is essential.

### SUMMARY

Disclosed herein is technology, including systems, methods, and devices for handling data transfer operations within the context of a split DMA controller.

In one example embodiment, a DMA controller includes primary DMA channel circuits coupled to a first set of devices, secondary DMA channel circuits coupled to a second set of devices, a packet switch coupled to both the primary and secondary DMA channel circuits, and a state machine coupled to the packet switch. In an implementation, the state machine is configured to receive a request to transmit data via a first channel circuit of the primary DMA channel circuits to a device associated with a second channel circuit of the secondary DMA channel circuits. In response to the request, the state machine is configured to determine that the second channel circuit is available and responsively pair the first channel circuit with the second channel circuit. Once paired, the state machine is configured to enable a virtual channel that is associated with the device and the second channel circuit. The state machine is then configured to instruct the first channel circuit to transmit the data via the packet switch to the second channel circuit. One transmitted, the state machine is configured to cause the second channel circuit to write the data to the device using the virtual channel.

In a second example embodiment, a DMA controller includes data path circuitry including a set of primary DMA channel circuits configured to couple to a memory, and state machine circuitry coupled to the data path circuitry. In an implementation, the state machine circuitry is first configured to receive a request to transmit data via a first channel circuit of the primary DMA channel circuits to a device associated with a second channel circuit of a set of secondary DMA channel circuits. In response to the request, the state machine circuitry is configured to determine that the second channel circuit is available and responsively pair the first channel circuit with the second channel circuit. Once paired, the state machine circuitry is then configured to enable a virtual channel that is associated with the device and the second channel circuit. Next, the state machine circuitry is configured to instruct the data path circuitry to transmit the data from the first channel circuit to the second channel circuit. Once transmitted, the state machine circuitry is configured to cause the second channel circuit to write the data to the device using the virtual channel.

In a third example embodiment, a non-transitory computer-readable medium having program instructions stored thereon, configured to be executable by processing circuitry is provided. In an implementation, when executed by the processing circuitry, the program instructions cause the processing circuitry to cause DMA circuitry that includes primary DMA circuitry, secondary DMA circuitry, and a packet switch coupled between the primary DMA circuitry and the secondary DMA circuitry to identify a first DMA channel circuit coupled to a first device that stores a set of data, and identify a second DMA channel circuit coupled to a second device that is capable of receiving the set of data. Once identified, the program instructions cause the processing circuitry to cause the DMA circuitry to enable a communication path between the first DMA channel circuit and the second DMA channel circuit. Once enabled, the program instructions cause the processing circuitry to cause the DMA circuitry to enable a virtual channel associated with the second device. Next, the program instructions cause the processing circuitry to cause the DMA circuitry to provide the set of data from the first device to the second DMA channel circuit via the first DMA channel circuit and the packet switch. Finally, the program instructions cause the processing circuitry to cause the DMA circuitry to provide the set of data from the second DMA channel circuit to the second device using the virtual channel.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system in an implementation.

FIG. 2 illustrates a method in an implementation.

FIGS. 3A and 3B illustrate sequence diagrams in various implementations.

FIG. 4 illustrates another system in an implementation.

FIG. 5 illustrates a state machine diagram in an implementation.

FIG. 6 illustrates an operational scenario in an implementation.

FIG. 7 illustrates another method in an implementation.

### DETAILED DESCRIPTION

Systems, methods, and devices are disclosed herein that provide an improved process for routing data via a split DMA controller within the context of a low-cost SoC. The disclosed technique(s) may be implemented in the context of hardware, software, firmware, or a combination thereof to provide a DMA controller that includes virtual channels for routing data to various low-latency peripherals. Advantageously, the proposed technology provides a split DMA controller that is suitable for systems that aim to minimize area, cost, and energy usage.

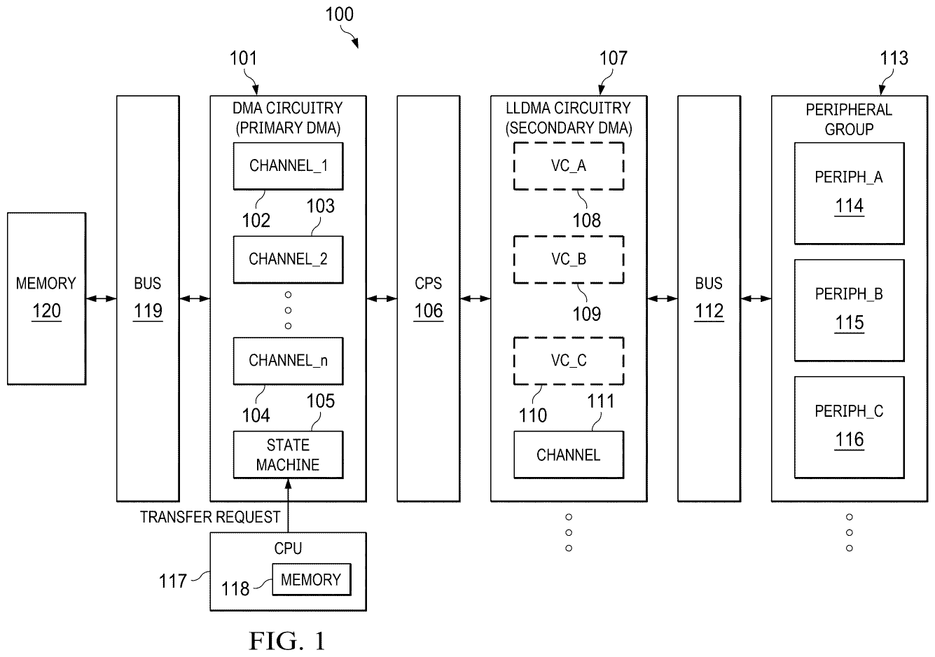

FIG. 1 illustrates system 100 in an implementation. System 100 is representative of an exemplary system that employs a DMA controller for performing various data transfer operations. For example, system 100 may depict a low-cost system, such as an automotive system, industrial system, or consumer device, that utilizes a split DMA controller for exchanging data between a high-latency memory and various low-latency peripherals. System 100 includes, but is not limited to, DMA circuitry 101, configurable packet switch (CPS) 106, low-latency DMA (LLDMA) circuitry 107, bus 112, peripheral group 113, central processing unit (CPU) 117, bus 119, and memory 120.

DMA circuitry 101 represents the primary DMA portion of a split DMA controller. For example, DMA circuitry 101 may support high-latency circuitry and may be capable of interfacing with a high-latency, high-bandwidth memory, such as flash memory. In an implementation, DMA circuitry 101 receives transfer requests from an associated CPU. A transfer request refers to a request for data to be moved from a source to one or more destinations. For example, CPU 117 may supply transfer requests to DMA circuitry 101, requesting data to be transferred between memory 120 and the peripherals of peripheral group 113. DMA circuitry 101 includes, but is not limited to, circuitry for primary DMA channels 102, 103, and 104, and state machine 105.

Primary DMA channels 102, 103, and 104 represent a number of DMA channels that transfer data to and from an associated memory. For example, primary DMA channels 102, 103, and 104 may depict hardware, software, firmware, or a combination thereof that transfer data to and from memory 120. In an implementation, each of primary DMA channels 102, 103, and 104 corresponds to a distinct section within memory 120. For example, primary DMA channel 102 may access data stored within a first address range of memory 120, primary DMA channel 103 may access data stored within a second address range of memory 120, and primary DMA channel 104 may access data stored within a third address range of memory 120, such that the first, second, and third address ranges span the full address space of memory 120. In another implementation, each of primary DMA channels 102, 103, and 104 is capable of accessing data from any location within memory 120. For example, primary DMA channels 102, 103, and 104 may each have access to the full address space of memory 120. In either case, primary DMA channels 102, 103, and 104 function as high-latency DMA channels, optimized for handling large-volume data transfers where relatively high start-up latency is expected and relatively large data transfers are possible after start-up. For example, primary DMA channels 102, 103, and 104 may each be associated with a first-in, first-out (FIFO) buffer that is capable of storing large amounts of data.

In an implementation, primary DMA channels 102, 103, and 104 are each associated with a configuration register. A configuration register is a register that allows system 100 to temporarily pair a respective primary DMA channel to the appropriate secondary DMA channel. For example, the configuration registers associated with primary DMA channels 102, 103, and 104, may each be configured to store the channel identifier (ID) of secondary DMA channel 111. In an implementation, when requested, state machine 105 stores the channel ID of a secondary DMA channel within the configuration registers that are associated with primary DMA channels 102, 103, and 104.

State machine 105 is representative of circuitry that is responsible for establishing the connections for servicing a transfer request. For example, state machine 105 may depict a hardware state machine that is configured to enable the appropriate pathways for exchanging data between memory 120 and the peripherals of peripheral group 113. In an implementation, state machine 105 receives transfer requests from CPU 117. For example, CPU 117 may request state machine 105 to transfer data from memory 120 to peripheral 115, and in response, state machine 105 identifies the primary and secondary DMA channels for servicing the transfer request and pairs said channels together.

In an implementation, to establish the pairing between a primary DMA channel and a secondary DMA channel, state machine 105 stores the channel ID of the secondary DMA channel within the configuration register of the primary DMA channel, and vice versa. For example, to establish the pairing between primary DMA channel 103 and secondary DMA channel 111, state machine 105 writes the channel ID of secondary DMA channel 111 to the configuration register of primary DMA channel 103 and writes the channel ID of primary DMA channel 103 to the configuration register of secondary DMA channel 111. As a result, state machine 105 enables the path in CPS 106 which connects primary DMA channel 103 to secondary DMA channel 111.

Once enabled, state machine 105 identifies the appropriate virtual channel for servicing the transfer request and enables said virtual channel. For example, if CPU 117 requests state machine 105 to transfer data from memory 120 to peripheral 115, then state machine 105 determines that virtual channel 109 is associated with peripheral 115 and responsively enables virtual channel 109. More specifically, state machine 105 stores an enable bit (e.g., 1) within a register that is associated with virtual channel 109 via CPS 106. As a result, state machine 105 causes secondary DMA channel 111 to temporarily serve as virtual channel 109 and route data to peripheral 115.

In an implementation, state machine 105 is further responsible for tearing down a previously enabled path. For example, CPU 117 may supply a teardown request to state machine 105, requesting state machine 105 to disable the path that connects primary DMA channel 103 to secondary DMA channel 111. In response, state machine 105 removes the channel ID of secondary DMA channel 111 from the configuration register of primary DMA channel 103 and further removes the channel ID of primary DMA channel 103 from the configuration register of secondary DMA channel 111. As a result, state machine 105 disables the path in CPS 106 which connects primary DMA channel 103 to secondary DMA channel 111. Once disabled, state machine 105 utilizes CPS 106 to disable the associated virtual channel. For example, if virtual channel 109 was previously enabled, then state machine 105 may utilize CPS 106 to store a disable bit (e.g., 0) in the register that is associated with virtual channel 109, thereby allowing secondary DMA channel 111 to service subsequent transfer requests.

CPS 106 is representative of circuitry that includes pathways for connecting the primary DMA channels of DMA circuitry 101 to the secondary DMA channel of LLDMA circuitry 107. For example, CPS 106 may depict a crossbar switch that includes at least three pathways for connecting primary DMA channels 102, 103, and 104 to secondary DMA channel 111. In an implementation, CPS 106 includes dedicated pathways that allow state machine 105 to communicate with LLDMA circuitry 107. For example, CPS 106 may include pathways that allow state machine 105 to populate the registers of LLDMA circuitry 107.

LLDMA circuitry 107 represents the secondary DMA portion of a split DMA controller. For example, LLDMA circuitry 107 may support low-latency circuitry and be capable of interfacing with a low-latency peripheral group. It should be noted that system 100 is not limited to LLDMA circuitry 107, but for the purposes of explanation, LLDMA circuitry 107 will be discussed herein. This specification is not meant to limit the applications of system 100, but rather, to provide an example. LLDMA circuitry 107 includes, but is not limited to, circuitry for virtual channels 108, 109, and 110, and secondary DMA channel 111.

Virtual channels 108, 109, and 110 represent a set of logically defined DMA channels. A logically defined DMA channel is a channel whose functionality is realized through the hardware of a corresponding physical DMA channel. By supporting virtual channels, the physical DMA channel can support communications with multiple endpoints in a time-interleaved manner. For example, virtual channels 108, 109, and 110 may be implemented within the hardware of secondary DMA channel 111. As such, virtual channels 108, 109, and 110 serve as secondary DMA channels that exchange data with a respective low-latency peripheral. For example, virtual channel 108 may be used to exchange data with peripheral 114 through secondary DMA channel 111, virtual channel 109 may be used to exchange data with peripheral 115 through secondary DMA channel 111, and virtual channel 110 may be used to exchange data with peripheral 116 also through secondary DMA channel 111. In embodiments with more than one secondary DMA channel, the virtual DMA channels may be fully associative, where any of the secondary DMA channels may be associated with any of the virtual DMA channels. Additionally, or in the alternative, some of the virtual DMA channels may be restricted to only a subset of the secondary DMA channels. It should be noted that the number of enabled virtual channels within an LLDMA circuit may be equal to (or less than) the number of peripherals within the corresponding peripheral group.

In particular, the virtual DMA channels may be used to communicate between secondary DMA channel 111 and a respective one of peripherals 114, 115, and 116 using bus 112. In an example, secondary DMA channel 111 includes an ID of the respective virtual channel in communications directed to the respective peripheral, which causes bus 112 to direct the communications to the peripheral. Likewise, the peripheral may include the virtual channel ID in communications directed to secondary DMA channel 111, which causes bus 112 to direct the communications to the secondary DMA channel 111.

In an implementation, virtual channels 108, 109, and 110 are each associated with a register that indicates which of virtual channels 108, 109, or 110 currently has access to secondary DMA channel 111. For example, virtual channels 108, 109, and 110 may each be associated with a memory-mapped register (MMR), that when enabled, indicates that the corresponding virtual channel has access to secondary DMA channel 111, and when disabled, indicates that the corresponding virtual channel does not have access to secondary DMA channel 111. Thus, for an LLDMA circuit that includes a single physical channel, only one virtual channel MMR may be enabled at any given time.

Secondary DMA channel 111 is representative of a DMA channel that provides the underlying mechanism for exchanging data via a virtual channel. For example, secondary DMA channel 111 may depict hardware, software, firmware, or a combination thereof that transfers data to and from peripherals 114, 115, and 116. In an implementation, secondary DMA channel 111 functions as a low-latency DMA channel that is optimized for handling small-volume data transfers. For example, secondary DMA channel 111 may be associated with a FIFO buffer that is only capable of storing small amounts of data. In an implementation, secondary DMA channel 111 is associated with a configuration register that allows system 100 to temporarily pair secondary DMA channel 111 to the appropriate primary DMA channel. For example, the configuration register associated with secondary DMA channel 111 may be configured to store the channel ID of primary DMA channels 102, 103, or 104.

Bus 112 is representative of circuitry that facilitates the transmission of data between the secondary portion of a split DMA controller and various low-latency peripherals. For example, bus 112 may transfer data between LLDMA circuitry 107 and peripheral group 113. In an implementation, bus 112 depicts a bidirectional bus that transfers small amounts of data. For example, the width of bus 112 may be equal to 8-bits, 16-bits, or 32-bits. As such, bus 112 is well-suited for transferring data between LLDMA circuitry 107 and the low-latency peripherals of peripheral group 113.

Peripheral group 113 represents a collection of low-latency devices including peripherals 114, 115, and 116. Peripherals 114, 115, and 116 are representative of low-latency devices, such as I/O devices, sensors, communication devices/interfaces (e.g., SPI, I2C, UART), or another low-latency peripheral of the like. In an implementation, the peripherals within peripheral group 113 include peripherals that operate out-of-phase with each other. For example, if a first peripheral (e.g., peripheral 114) of peripheral group 113 is active, then the remaining peripherals of peripheral group 113 (e.g., peripherals 115 and 116) are inactive.

In an implementation, peripherals 114, 115, and 116 are each mapped to a corresponding virtual channel. More specifically, peripheral 114 is associated with virtual channel 108, peripheral 115 is associated with virtual channel 109, and peripheral 116 is associated with virtual channel 110. However, each peripheral of peripheral group 113 transmits and receives data via secondary DMA channel 111. For example, CPU 117 may issue a request for data to be transferred from memory 120 to peripheral 116, and in response, state machine 105 enables the appropriate pathways for transmitting the data to secondary DMA channel 111. Once enabled, state machine 105 enables virtual channel 110 to cause secondary DMA channel 111 to transmit the data to peripheral 116.

CPU 117 is representative of circuitry that manages the operations of system 100. For example, if system 100 is implemented within the automotive context, then CPU 117 may execute program code related to motor control, airbag deployment, infotainment, and other functionalities of the like. In an implementation, CPU 117 executes program code stored in CPU memory 118.

CPU memory 118 is representative of a memory that stores data, instructions, and the like for CPU 117. For example, CPU memory 118 may depict cache memory, static random-access memory (SRAM), dynamic random-access memory (DRAM), or another on-chip memory of the like that stores program code for CPU 117, such that in no case is CPU memory 118 a propagated signal. In an implementation, the program code stored by CPU memory 118 causes CPU 117 to issue various types of requests. For example, the program code stored by CPU memory 118 may cause CPU 117 to issue either transfer requests or teardown requests. A transfer request refers to a request to enable a path for transferring data between memory 120 and the peripherals of peripheral group 113. Alternatively, a teardown request refers to a request for a previously enabled path to be disabled. In an implementation, CPU 117 interfaces with DMA circuitry 101 via a bus (not shown).

Memory 120 is representative of a memory that stores data, instructions, and the like for system 100. For example, memory 120 may depict flash memory, DRAM, read-only memory (ROM), or another external memory of the like, such that in no case is memory 120 a propagated signal. In an implementation, memory 120 is a relative high-latency memory capable of storing and transferring large volumes of data. For example, memory 120 may be capable of storing tens of megabytes to several gigabytes of data and transferring the data at up to 1 Gbps or more. In an implementation, DMA circuitry 101 accesses data from memory 120 via bus 119.

Bus 119 is representative of circuitry that facilitates the transmission of data between the primary DMA portion of a split DMA controller and an external memory. For example, bus 119 may transfer data between DMA circuitry 101 and memory 120. In an implementation, bus 119 depicts a bidirectional bus that can transfer large amounts of data. For example, the width of bus 119 may be equal to 64-bits, 128-bits, or greater. As such, bus 119 is well-suited for transferring data between a high-latency, high-bandwidth memory, such as memory 120, and DMA circuitry 101.

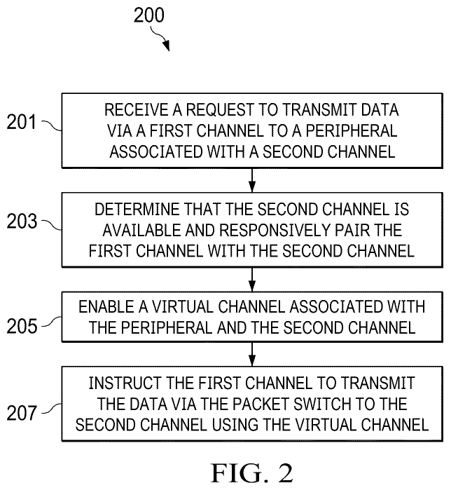

FIG. 2 illustrates method 200 in an implementation. Method 200 is representative of a technique for servicing a transfer request within the context of a split DMA controller that employs virtual channels. For example, method 200 may provide a technique for transferring data from a high-latency source to a low-latency destination via a virtual channel. Method 200 may be implemented in the context of hardware, firmware, or software to cause a system to operate as follows, referring parenthetically to the steps in FIG. 2. For the purposes of explanation, method 200 will be explained with respect to the elements of FIG. 1. This is not meant to limit the applications of method 200, but rather to provide an example for purposes of illustration.

To begin, state machine 105 receives a transfer request from CPU 117 to transmit data from memory 120 to a designated peripheral (step 201). For example, CPU 117 may initiate a request to transfer data from a specific location within memory 120 to peripheral 115. In response, state machine 105 identifies the appropriate primary DMA channel for servicing the transfer request.

In an implementation, to identify the appropriate primary DMA channel, state machine 105 determines which of primary DMA channels 102, 103, and 104 has access to the requested data as stored in memory 120. For example, CPU 117 may request that data be transferred from a location within memory 120 that only primary DMA channel 103 has access to. In another implementation, to identify the appropriate primary DMA channel, state machine 105 evaluates the availability of primary DMA channels 102, 103, and 104 to determine which channel is currently available for servicing the transfer request. For example, state machine 105 may determine that primary DMA channels 102 and 104 are currently occupied with servicing other transfer requests, thereby making primary DMA channel 103 the only available channel for servicing the transfer request. As a result, state machine 105 classifies primary DMA channel 103 as the primary DMA channel for servicing the transfer request.

Next, state machine 105 determines whether secondary DMA channel 111 is available for servicing the transfer request. For example, state machine 105 may check the MMRs associated with virtual channels 108, 109, and 110 to determine if secondary DMA channel 111 is currently occupied servicing another transfer request. If state machine 105 determines that any of the MMRs are enabled, then state machine 105 determines that secondary DMA channel 111 is unavailable for servicing the transfer request and responsively outputs a fault indicator. Alternatively, if state machine 105 determines that each of the MMRs is disabled, then state machine 105 determines that secondary DMA channel 111 is available for servicing the transfer request and responsively pairs secondary DMA channel 111 to primary DMA channel 103 (step 203).

For example, state machine 105 may store the channel ID of secondary DMA channel 111 within the configuration register of primary DMA channel 103. Once stored, state machine 105 may then utilize CPS 106 to store the channel ID of primary DMA channel 103 within the configuration register of secondary DMA channel 111. As a result, state machine 105 pairs primary DMA channel 103 with secondary DMA channel 111. More specifically, state machine 105 enables the path in CPS 106 which connects primary DMA channel 103 to secondary DMA channel 111.

Next, state machine 105 identifies the appropriate virtual channel for servicing the transfer request. For example, state machine 105 may determine that virtual channel 109 is associated with peripheral 115, and in response, utilize CPS 106 to write an enable value to the MMR that is associated with virtual channel 109 (step 205). As a result, state machine 105 causes secondary DMA channel 111 to function as virtual channel 109.

Finally, state machine 105 instructs DMA circuitry 101 to fetch the requested data from memory 120 and write the data to peripheral 115 (step 207). For example, DMA circuitry 101 may access the data from memory 120 and transmit the data to a buffer and/or other communication hardware associated with primary DMA channel 103 via bus 119. Once transmitted, CPS 106 transmits the data from primary DMA channel 103 to a buffer and/or other communication hardware associated with secondary DMA channel 111 (i.e., virtual channel 109) via the enabled path. In response, LLDMA circuitry 107 transmits the data from virtual channel 109 to peripheral 115 via bus 112.

In an implementation, after servicing the transfer request, CPU 117 requests state machine 105 to disable the recently enabled path. For example, CPU 117 may output a teardown request to state machine 105, requesting state machine 105 to disable the path within CPS 106 that connects primary DMA channel 103 to secondary DMA channel 111. In response, state machine 105 removes the channel ID of secondary DMA channel 111 from the configuration register of primary DMA channel 103 and removes the channel ID of primary DMA channel 103 from the configuration register of secondary DMA channel 111. State machine 105 then disables the MMR associated with virtual channel 109, thereby making secondary DMA channel 111 available to service a subsequent transfer request.

Advantageously, method 200 provides a technique for servicing transfer requests within the context of a split DMA controller that reduces the number of dedicated secondary DMA channels. Instead, method 200 leverages virtual channels to manage the exchange of data between a high-latency memory and various low-latency peripherals. As a result, method 200 is particularly well-suited for resource-constrained environments, such as embedded systems or low-power applications, where minimizing area, reducing system cost, and conserving energy are critical design goals.

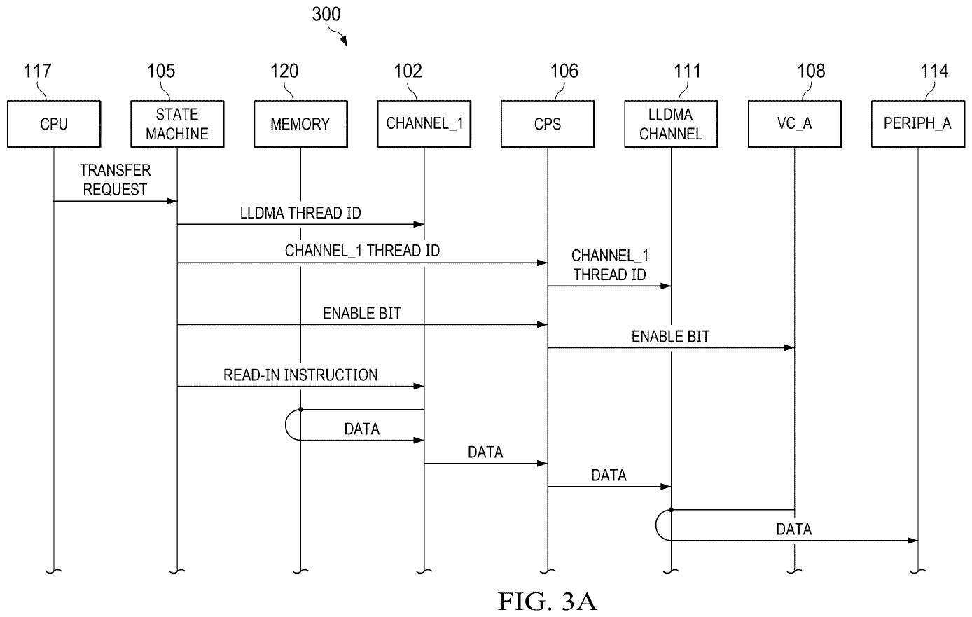

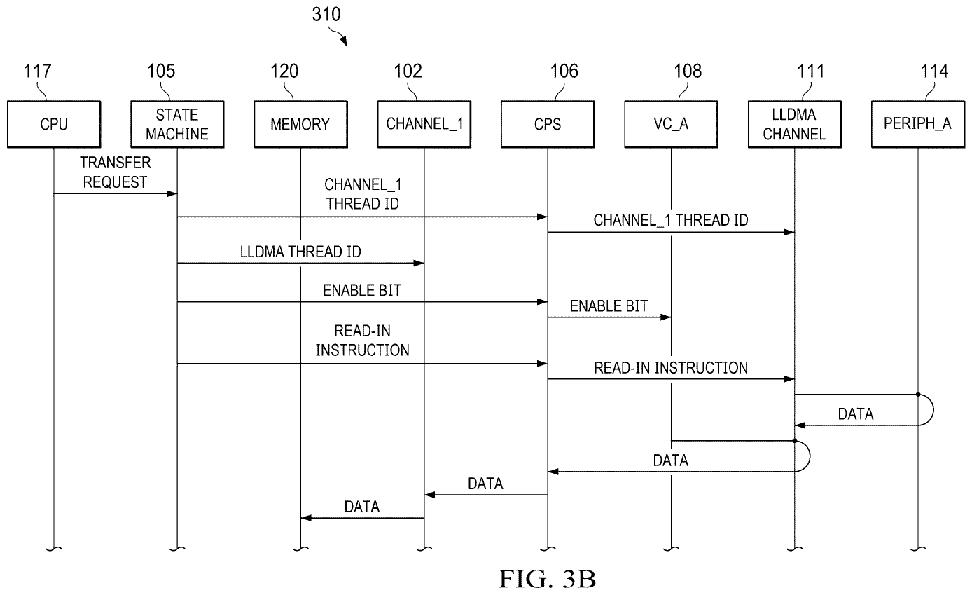

FIG. 3A illustrates sequence diagram 300 in an implementation. Sequence diagram 300 is representative of an operational sequence for servicing a transfer request with respect to the elements of FIG. 1. In an implementation, sequence diagram 300 depicts an operational sequence for transmitting data from a high-latency memory to a low-latency peripheral device. Sequence diagram 300 includes CPU 117, state machine 105, memory 120, primary DMA channel 102, CPS 106, secondary DMA channel 111, virtual channel 108, and peripheral 114.

To begin, CPU 117 outputs a transfer request to state machine 105, and in response, state machine 105 identifies the appropriate primary DMA channel for servicing the request. For example, CPU 117 may output a request to transfer data from a specific location within memory 120 to peripheral 114, and in response, state machine 105 may determine that primary DMA channel 102 is the only channel that has access to the requested data. As such, state machine 105 classifies primary DMA channel 102 as the appropriate channel for servicing the transfer request.

Next, state machine 105 determines whether secondary DMA channel 111 is available for servicing the transfer request. For example, state machine 105 may evaluate the MMRs associated with virtual channels 108, 109, and 110 to determine whether secondary DMA channel 111 is currently available to service the transfer request or occupied with another transfer request. In response to determining that secondary DMA channel 111 is available, state machine 105 pairs primary DMA channel 102 to secondary DMA channel 111.

For example, state machine 105 may write the thread ID of secondary DMA channel 111 to the configuration register of primary DMA channel 102. Once written, state machine 105 may utilize CPS 106 to write the thread ID of primary DMA channel 102 to the configuration register of secondary DMA channel 111. For example, state machine 105 may use a dedicated path within CPS 106 that is designed for transmitting configuration information to write the thread ID of primary DMA channel 102 to the configuration register of secondary DMA channel 111. As a result, state machine 105 enables the path in CPS 106 that connects primary DMA channel 102 to secondary DMA channel 111.

Next, state machine 105 determines that virtual channel 108 is associated with peripheral 114 and responsively enables virtual channel 108. For example, state machine 105 may use a dedicated path within CPS 106 that is designed for transmitting enable bits to write to the MMR associated with virtual channel 108. As a result, state machine 105 causes secondary DMA channel 111 to function as virtual channel 108.

Finally, state machine 105 outputs an instruction to DMA circuitry 101, requesting DMA circuitry 101 to read-in the data from memory 120 and write the data to peripheral 114. In response, DMA circuitry 101 accesses the data from memory 120 and transmits the data across primary DMA channel 102 to CPS 106. Next, CPS 106 transmits the data to LLDMA circuitry 107 via the path that was enabled by state machine 105. In response, LLDMA circuitry 107 transmits the data across secondary DMA channel 111, which is currently serving as virtual channel 109, to peripheral 114.

FIG. 3B illustrates sequence diagram 310 in an implementation. Sequence diagram 310 is representative of an operational sequence for servicing a transfer request with respect to the elements of FIG. 1. In an implementation, sequence diagram 310 depicts an operational sequence for transmitting data from a low-latency peripheral device to a high-latency memory. Sequence diagram 310 includes CPU 117, state machine 105, memory 120, primary DMA channel 102, CPS 106, virtual channel 108, secondary DMA channel 111, and peripheral 114.

To begin, CPU 117 outputs a transfer request to state machine 105, and in response, state machine 105 determines the appropriate primary DMA channel for servicing the request. For example, CPU 117 may output a request to transfer data from peripheral 114 to a specific location within memory 120, and in response, state machine 105 determines that primary DMA channel 102 is the only channel that has access to said location within memory 120. As such, state machine 105 classifies primary DMA channel 102 as the appropriate channel for servicing the transfer request.

Next, state machine 105 determines whether secondary DMA channel 111 is available for servicing the transfer request. For example, state machine 105 may evaluate the MMRs associated with virtual channels 108, 109, and 110 to determine whether secondary DMA channel 111 is currently available to service the request or occupied with another request. In response to determining that secondary DMA channel 111 is available, state machine 105 pairs primary DMA channel 102 to secondary DMA channel 111.

For example, state machine 105 may use the path within CPS 106 that is dedicated to transmitting configuration information to write the thread ID of primary DMA channel 102 to the configuration register of secondary DMA channel 111. Once written, state machine 105 may then write the thread ID of secondary DMA channel 111 to the configuration register of primary DMA channel 102. As a result, state machine 105 enables the path in CPS 106 that connects secondary DMA channel 111 to primary DMA channel 102.

Next, state machine 105 determines that virtual channel 108 is associated with peripheral 114 and responsively enables virtual channel 108. For example, state machine 105 may use the path within CPS 106 that is dedicated to transmitting enable bits to write to the MMR associated with virtual channel 108. As a result, state machine 105 causes secondary DMA channel 111 to function as virtual channel 108.

Finally, state machine 105 outputs an instruction to LLDMA circuitry 107 via CPS 106, requesting LLDMA circuitry 107 to read-in the data from peripheral 114 and write the data to memory 120. In response, LLDMA circuitry 107 accesses the data from peripheral 114 and transmits the data across secondary DMA channel 111, which is currently serving as virtual channel 109, to CPS 106. Next, CPS 106 transmits the data to DMA circuitry 101 via the path that was enabled by state machine 105. In response, DMA circuitry 101 transmits the data across primary DMA channel 102 to the specified location within memory 120.

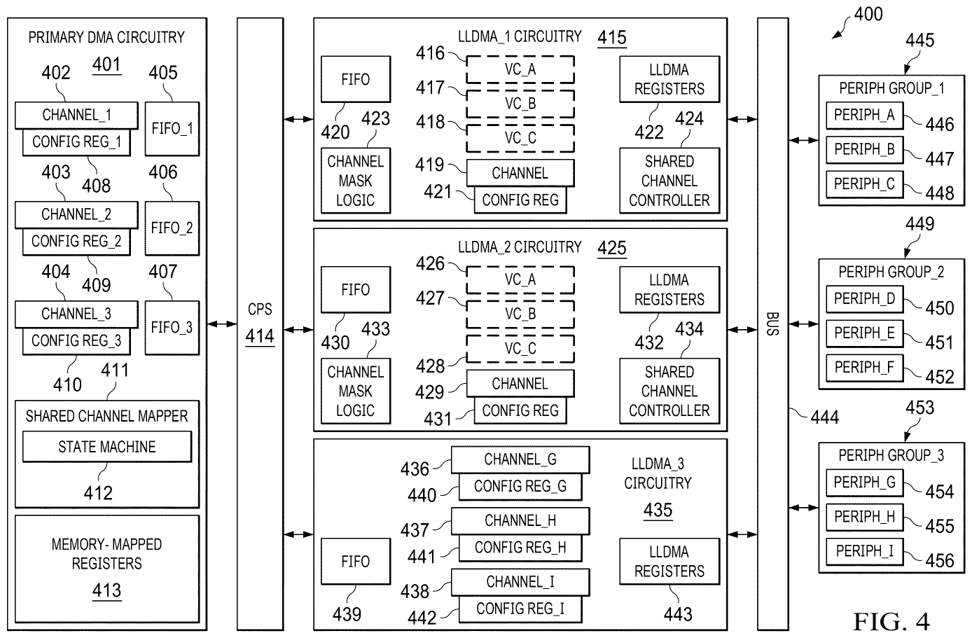

FIG. 4 illustrates system 400 in an implementation. System 400 is representative of another exemplary system that employs a split DMA controller for performing various data transfer operations. For example, system 400 may represent system 100 of FIG. 1. System 400 includes, but is not limited to, primary DMA circuitry 401, CPS 414, LLDMA circuitries 415, 425, and 435, bus 444, and peripheral groups 445, 449, and 453.

Primary DMA circuitry 401 represents the primary portion of a split DMA controller. For example, primary DMA circuitry 401 may depict circuitry (e.g., DMA circuitry 101) that is capable of interfacing with a high-latency memory. Primary DMA circuitry 401 includes, but is not limited to, primary DMA channels 402, 403, and 404, FIFO buffers 405, 406, and 407, configuration registers 408, 409, and 410, shared channel mapper 411, and MMRs 413.

Primary DMA channels 402, 403, and 404 represent DMA channels (e.g., primary DMA channels 102, 103, and 104) that transfer data to and from an associated memory. For example, primary DMA channels 402, 403, and 404 may depict hardware, software, firmware, or a combination thereof, capable of performing large-volume data transfers with respect to an external memory (e.g., memory 120) and/or other high-latency devices. In an implementation, each channel of primary DMA channels 402, 403, and 404 has access to a specific section within the associated memory. For example, primary DMA channel 402 may access data stored within a first address range of the associated memory, primary DMA channel 403 may access data stored within a second address range of the associated memory, and primary DMA channel 404 may access data stored within a third address range of the associated memory, such that the first, second, and third address ranges span the full address space of the associated memory. For example, some or all of the first, second, and third address ranges may correspond to regions of memory 120. In an implementation, each channel of primary DMA channels 402, 403, and 404 is associated with a FIFO buffer and a configuration register. For example, primary DMA channel 402 may be associated with FIFO buffer 405 and configuration register 408, primary DMA channel 403 may be associated with FIFO buffer 406 and configuration register 409, and primary DMA channel 404 may be associated with FIFO buffer 407 and configuration register 410.

FIFO buffers 405, 406, and 407 are representative of local memories that store transmission data for a respective primary DMA channel. For example, FIFO buffers 405, 406, and 407 may depict memories that respectively store transmission data for primary DMA channels 402, 403, and 404. In an implementation, FIFO buffers 405, 406, and 407 are housed by an on-chip memory. For example, primary DMA circuitry 401 may include cache memory, SRAM, DRAM, or another on-chip memory of the like that includes FIFO buffers 405, 406, and 407. In another implementation, FIFO buffers 405, 406, and 407 are housed by an off-chip memory. For example, FIFO buffers 405, 406, and 407 may be stored by an external memory (not shown). In either case, FIFO buffers 405, 406, and 407 depict local memories that enable primary DMA circuitry 401 to respectively transfer data across primary DMA channels 402, 403, and 404.

Configuration registers 408, 409, and 410 are representative of registers that allow system 400 to temporarily pair a respective primary DMA channel to the appropriate secondary DMA channel. For example, configuration registers 408, 409, and 410 may each be configured to store the channel ID of secondary DMA channels 419, 429, 436, 437, or 438. In an implementation, configuration registers 408, 409, and 410 are populated by shared channel mapper 411.

Shared channel mapper 411 is representative of circuitry that controls the operations of primary DMA circuitry 401. For example, shared channel mapper 411 may depict a CPU, microcontroller unit (MCU), application-specific integrated circuit (ASIC), or another general-purpose processor (GPP) of the like that manages the operations required for servicing a transfer request. Shared channel mapper 411 includes state machine 412.

State machine 412 is representative of circuitry (e.g., state machine 105) that is capable of servicing transfer requests. For example, state machine 412 may depict a hardware state machine that establishes the connections for transferring data between an external memory and the peripherals of peripheral groups 445, 449, and 453. In an implementation, state machine 412 receives transfer requests from an associated CPU (e.g., CPU 117), and in response, instructs shared channel mapper 411 to pair the DMA channels for servicing the transfer request. For example, if the associated CPU issues a transfer request to transfer data from an external memory to peripheral 451, then state machine 412 identifies the primary and secondary DMA channels for servicing the transfer request and responsively instructs shared channel mapper 411 to pair said channels together. In an implementation, state machine 412 receives transfer requests via MMRs 413.

MMRs 413 are representative of registers that indicate whether a respective DMA channel is available for transferring data to or from a specific peripheral. For example, MMRs 413 may include a first set of MMRs corresponding to primary DMA channel 402, a second set of MMRs corresponding to primary DMA channel 403, a third set of MMRs corresponding to primary DMA channel 404, and a fourth set of MMRs corresponding to secondary DMA channels 419, 429, 436, 437, and 438. The first set of MMRs includes nine registers that indicate the availability of primary DMA channel 402 with respect to peripherals 446, 447, 448, 450, 451, 452, 454, 455, and 456. The second set of MMRs includes nine registers that indicate the availability of primary DMA channel 403 with respect to peripherals 446, 447, 448, 450, 451, 452, 454, 455, and 456. The third set of MMRs includes nine registers that indicate the availability of primary DMA channel 404 with respect to peripherals 446, 447, 448, 450, 451, 452, 454, 455, and 456. The fourth set of MMRs includes a first register that indicates the availability of secondary DMA channel 419 with respect to peripherals 446, 447, and 448, a second register that indicates the availability of secondary DMA channel 429 with respect to peripherals 450, 451, and 452, a third register that indicates the availability of secondary DMA channel 436 with respect to peripheral 454, a fourth register that indicates the availability of secondary DMA channel 437 with respect to peripheral 455, and a fifth register that indicates the availability of secondary DMA channel 438 with respect to peripheral 456. As such, MMRs 413 includes at least thirty-two registers for indicating the availability of primary DMA channels 402, 403, and 404, and secondary DMA channels 419, 429, 436, 437, and 438.

In an implementation, an associated CPU supplies transfer requests to state machine 412 via MMRs 413. For example, if the associated CPU wishes to transfer data from a specific location within an external memory to peripheral 451, then the associated CPU identifies which primary DMA channel has access to the requested data. Once identified, the associated CPU attempts to enable the appropriate MMR for servicing the transfer request. For example, if the associated CPU wishes to transfer data from a specific location within the external memory to peripheral 451, and the CPU identifies primary DMA channel 404 as the channel which has access to the requested data, then the associated CPU checks if the MMR corresponding to primary DMA channel 404 servicing peripheral 451 is enabled or disabled.

If the MMR is enabled, then the associated CPU determines that primary DMA channel 404 is currently unavailable for servicing the transfer request. In an implementation, if the associated CPU determines that the desired MMR is enabled, then the associated CPU determines whether to disable said MMR. For example, the associated CPU may determine if primary DMA channel 404 and/or secondary DMA channel 429 are currently occupied servicing a separate transfer request. If either channel is occupied, then the associated CPU outputs a fault indicator and waits to write a disable value to the MMR corresponding to primary DMA channel 404 servicing peripheral 451. Alternatively, if neither channel is occupied, then the associated CPU disables the MMR corresponding to primary DMA channel 404 servicing peripheral 451. Once disabled, the associated CPU may then re-write the enable value to the MMR to trigger state machine 412 to service the transfer request.

Alternatively, if the MMR is disabled, then the associated CPU determines that primary DMA channel 404 is currently available for servicing the transfer request and responsively enables the MMR. As a result, the associated CPU triggers state machine 412 to service the transfer request. In an implementation, to service the transfer request, state machine 412 pairs the DMA channels that correspond to the enabled MMR. For example, if the associated CPU enables the MMR that corresponds to primary DMA channel 404 servicing peripheral 451, then state machine 412 identifies which secondary DMA channel (i.e., secondary DMA channel 429) is associated with peripheral 451. Once identified, state machine 412 checks MMRs 413 to determine if secondary DMA channel 429 is available for servicing the transfer request. For example, state machine 412 may check if the MMR corresponding to secondary DMA channel 429 is enabled or disabled.

If the MMR is enabled, then state machine 412 determines that secondary DMA channel 429 is currently unavailable for servicing the transfer request and responsively issues a fault indicator. For example, state machine 412 may output a warning to the associated CPU, indicating that the transfer request cannot be serviced. Alternatively, if the MMR is disabled, then state machine 412 determines that secondary DMA channel 429 is currently available for servicing the transfer request and responsively enables the MMR. Once enabled, state machine 412 instructs shared channel mapper 411 to write the channel ID of secondary DMA channel 429 to configuration register 410 and to write the channel ID of primary DMA channel 404 to configuration register 431. As a result, state machine 412 causes shared channel mapper 411 to enable the path in CPS 414 which connects primary DMA channel 404 to secondary DMA channel 429.

Once enabled, state machine 412 identifies the appropriate virtual channel for servicing the transfer request. For example, state machine 412 may determine that virtual channel 427 is associated with peripheral 451, and in response, state machine 412 may enable virtual channel 427. In an implementation, to enable a virtual channel, state machine 412 instructs shared channel mapper 411 to write an enable value in an MMR corresponding to the virtual channel. For example, to enable virtual channel 427, state machine 412 may instruct shared channel mapper 411 to write an enable value to the MMR corresponding to virtual channel 427. In response, shared channel mapper 411 utilizes a path in CPS 414 dedicated to transmitting enable bits to access LLDMA registers 432. Once accessed, shared channel mapper 411 stores an enable bit in the MMR corresponding to virtual channel 427. As a result, state machine 412 causes secondary DMA channel 429 to temporarily serve as virtual channel 427. More specifically, state machine 412 causes shared channel mapper 411 to configure secondary DMA channel 429 to route data to peripheral 451.

In another implementation, the associated CPU may also supply teardown requests to state machine 412 via MMRs 413. A teardown request refers to a request to disable a path within CPS 414 that was previously enabled. For example, if the associated CPU wishes to tear down the path in CPS 414 which connects primary DMA channel 404 to secondary DMA channel 429, then the associated CPU may write a disable value to the MMR corresponding to primary DMA channel 404 servicing peripheral 451. As a result, the associated CPU triggers state machine 412 to service the teardown request.

To service the teardown request, state machine 412 unpairs the DMA channels that correspond to the disabled MMR. For example, if the associated CPU disables the MMR corresponding to primary DMA channel 404 servicing peripheral 451, then state machine 412 instructs shared channel mapper 411 to remove the channel ID of secondary DMA channel 429 from configuration register 410 and to remove the channel ID of primary DMA channel 404 from configuration register 431. Once removed, state machine 412 instructs shared channel mapper 411 to write a disable value to the MMRs corresponding to secondary DMA channel 429 and virtual channel 427. As a result, shared channel mapper 411 disables the path in CPS 414 that connects primary DMA channel 404 to secondary DMA channel 429 and further disables virtual channel 427. More specifically, state machine 412 causes primary DMA channel 404 and secondary DMA channel 429 to become available for servicing a new transfer request.

CPS 414 is representative of circuitry (e.g., CPS 106) that includes pathways for connecting the primary DMA channels of primary DMA circuitry 401 to the secondary DMA channels of LLDMA circuitries 415, 425, and 435. For example, CPS 414 may depict a crossbar switch that includes at least fifteen pathways for connecting primary DMA channels 402, 403, and 404 to secondary DMA channels 419, 429, 436, 437, and 438. In an implementation, CPS 414 includes dedicated pathways that allow state machine 412 to communicate with LLDMA circuitries 415, 425, and 435. For example, CPS 414 may include pathways that allow shared channel mapper 411 to populate the registers of LLDMA circuitries 415, 425, and 435.

LLDMA circuitry 415 represents the secondary DMA portion (e.g., LLDMA circuitry 107) of a split DMA controller. For example, LLDMA circuitry 415 may depict hardware, software, firmware, or a combination thereof that is capable of interfacing with a corresponding low-latency peripheral group (i.e., peripheral group 445). LLDMA circuitry 415 includes, but is not limited to, virtual channels 416, 417, and 418, secondary DMA channel 419, FIFO buffer 420, configuration register 421, LLDMA registers 422, channel mask logic 423, and shared channel controller 424.

Virtual channels 416, 417, and 418 represent a set of logically defined DMA channels (e.g., virtual channels 108, 109, and 110) that are implemented via the hardware of secondary DMA channel 419. As such, virtual channels 416, 417, and 418 serve as secondary DMA channels that exchange data with a respective low-latency peripheral. For example, virtual channel 416 may exchange data with peripheral 446 through secondary DMA channel 419, virtual channel 417 may exchange data with peripheral 447 through secondary DMA channel 419, and virtual channel 418 may exchange data with peripheral 448 also through secondary DMA channel 419.

Secondary DMA channel 419 is representative of a DMA channel (e.g., secondary DMA channel 111) that provides the underlying mechanism for exchanging data via a virtual channel. For example, secondary DMA channel 419 may depict hardware, software, firmware, or a combination thereof that transfers small amounts of data to and from peripherals 446, 447, and 448. In an implementation, secondary DMA channel 419 is associated with FIFO buffer 420 and configuration register 421.

FIFO buffer 420 is representative of a local memory that stores transmission data for LLDMA circuitry 415. For example, FIFO buffer 420 may depict a memory that stores transmission data for secondary DMA channel 419, and in turn, virtual channels 416, 417, and 418. Due to the differences in the ways that devices coupled to primary DMA circuit 401 and devices coupled to LLDMA circuitry 415 transfer data, the sizes of FIFO buffers 405, 406, and 407 may be greater than the size of FIFO buffer 420 (and likewise greater than FIFO buffers 430 and 439). In an implementation, FIFO buffer 420 is housed by an on-chip memory. For example, LLDMA circuitry 415 may include cache memory, SRAM, DRAM, or another on-chip memory of the like that stores FIFO buffer 420. In another implementation, FIFO buffer 420 is housed by an off-chip memory. For example, FIFO buffer 420 may be stored by an associated external memory (e.g., memory 120). In either case, FIFO buffer 420 depicts a local memory that enables LLDMA circuitry 415 to transfer data across secondary DMA channel 419. It should be noted that LLDMA circuitry 415 is not limited to FIFO buffer 420. For example, LLDMA circuitry 415 may include a FIFO buffer for each of its virtual channels, but for the purposes of explanation, FIFO buffer 420 will be discussed herein. This specification is not meant to limit the applications of LLDMA circuitry 415, but rather, to provide an example.

Configuration register 421 represents a register that allows system 400 to temporarily pair secondary DMA channel 419 to the appropriate primary DMA channel. For example, configuration register 421 may be configured to store the channel ID of primary DMA channels 402, 403, or 404. In an implementation, when instructed by state machine 412, shared channel mapper 411 writes to, or removes data from configuration register 421.

LLDMA registers 422 are representative of registers that store information related to LLDMA circuitry 415. For example, LLDMA registers 422 may store the channel ID (e.g., thread ID) of secondary DMA channel 419, the number of available credits within FIFO buffer 420, the amount of available space within FIFO buffer 420, and the width of bus 444. In an implementation, state machine 412 references LLDMA registers 422 to service various transfer requests. For example, if state machine 412 is requested to pair primary DMA channel 403 to secondary DMA channel 417, then state machine 412 may instruct shared channel mapper 411 to access the data stored by LLDMA registers 422 to determine if FIFO buffer 420 has enough room for servicing the transfer request.

In an implementation, LLDMA registers 422 store MMRs that correspond to the virtual channels of LLDMA circuitry 415. For example, LLDMA registers 422 may include a first MMR corresponding to virtual channel 416, a second MMR corresponding to virtual channel 417, and a third MMR corresponding to virtual channel 418. The virtual channel MMRs are representative of registers that signify which virtual channel currently has access to secondary DMA channel 419. For example, if the MMR corresponding to virtual channel 416 is enabled, then secondary DMA channel 419 is configured to serve as virtual channel 416. Alternatively, if the MMR corresponding to virtual channel 416 is disabled, then secondary DMA channel 419 is available to serve as either virtual channel 417 or virtual channel 418. In an implementation, channel mask logic 423 and shared channel controller 424 reference the virtual channel MMRs to verify that data is routed to the intended destination.

Channel mask logic 423 is representative of a logical component that ensures data is traversing across the correct virtual channel. For example, channel mask logic 423 may depict hardware, software, firmware, or a combination thereof that verifies whether secondary DMA channel 419 is functioning as the appropriate virtual channel for servicing a transfer request. In an implementation, channel mask logic 423 provides a logical link between FIFO buffer 420 and the active virtual channel. For example, if the MMR corresponding to virtual channel 417 is enabled, then channel mask logic 423 may ensure that the data stored by FIFO buffer 420 is intended for peripheral 447.

Shared channel controller 424 is representative of circuitry that ensures data is routed to the desired peripheral. For example, shared channel controller 424 may depict a CPU, MCU, ASIC, or another GPP of the like that verifies whether secondary DMA channel 419 is routing data to the peripheral that was designated by the transfer request. In an example, data exchanged between FIFO 420 and shared channel controller 424 is tagged with an ID of the respective virtual channel, which causes shared channel controller 424 to direct the communications to the peripheral associated with the respective virtual channel.

In an implementation, channel mask logic 423 and shared channel controller 424 operate in tandem to ensure a transfer request is properly serviced.

LLDMA circuitry 425 is also representative of the secondary DMA portion (e.g., LLDMA circuitry 107) of a split DMA controller. For example, LLDMA circuitry 425 may depict hardware, software, firmware, or a combination thereof that is capable of interfacing with a corresponding low-latency peripheral group (i.e., peripheral group 449). LLDMA circuitry 425 includes, but is not limited to, virtual channels 426, 427, and 428, secondary DMA channel 429, FIFO buffer 430, configuration register 431, LLDMA registers 432, channel mask logic 433, and shared channel controller 434.

Virtual channels 426, 427, and 428 represent a set of logically defined DMA channels (e.g., virtual channels 108, 109, and 110) that are implemented via the hardware of secondary DMA channel 429. As such, virtual channels 426, 427, and 428 serve as secondary DMA channels that exchange data with a respective low-latency peripheral. For example, virtual channel 426 may exchange data with peripheral 450 through secondary DMA channel 429, virtual channel 427 may exchange data with peripheral 451 through secondary DMA channel 429, and virtual channel 428 may exchange data with peripheral 452 also through secondary DMA channel 429.

Secondary DMA channel 429 is representative of a DMA channel (e.g., secondary DMA channel 111) that provides the underlying mechanism for exchanging data via a virtual channel. For example, secondary DMA channel 429 may depict hardware, software, firmware, or a combination thereof that transfers small amounts of data to and from peripherals 446, 447, and 448. In an implementation, secondary DMA channel 429 is associated with FIFO buffer 430 and configuration register 431.

FIFO buffer 430 is representative of a local memory that stores transmission data for LLDMA circuitry 425. For example, FIFO buffer 430 may depict a low-latency memory that stores transmission data for secondary DMA channel 429, and in turn, virtual channels 426, 427, and 428. In an implementation, FIFO buffer 430 is housed by an on-chip memory. For example, LLDMA circuitry 425 may include cache memory, SRAM, DRAM, or another on-chip memory of the like that stores FIFO buffer 430. In another implementation, FIFO buffer 430 is housed by an off-chip memory. For example, FIFO buffer 430 may be stored by an associated external memory (e.g., memory 120). In either case, FIFO buffer 430 depicts a local memory that enables LLDMA circuitry 425 to transfer data across secondary DMA channel 429. It should be noted that LLDMA circuitry 425 is not limited to FIFO buffer 430. For example, LLDMA circuitry 425 may include a FIFO buffer for each of its virtual channels, but for the purposes of explanation, FIFO buffer 430 will be discussed herein. This specification is not meant to limit the applications of LLDMA circuitry 425, but rather, to provide an example.

Configuration register 431 represents a register that allows system 400 to temporarily pair secondary DMA channel 429 to the appropriate primary DMA channel. For example, configuration register 431 may be configured to store the channel ID of primary DMA channels 402, 403, or 404. In an implementation, when instructed by state machine 412, shared channel mapper 411 writes to, or removes data from configuration register 431.

LLDMA registers 432 are representative of registers that store information related to LLDMA circuitry 425. For example, LLDMA registers 432 may store the channel ID (e.g., thread ID) of secondary DMA channel 429, the number of available credits within FIFO buffer 430, the amount of available space within FIFO buffer 430, and the width of bus 444. In an implementation, state machine 412 references LLDMA registers 432 to service various transfer requests. For example, if state machine 412 is requested to pair primary DMA channel 403 to secondary DMA channel 427, then state machine 412 may instruct shared channel mapper 411 to access the data stored by LLDMA registers 432 to determine if FIFO buffer 430 has enough room for servicing the transfer request.

In an implementation, LLDMA registers 432 store MMRs that correspond to the virtual channels of LLDMA circuitry 425. For example, LLDMA registers 432 may include a first MMR corresponding to virtual channel 426, a second MMR corresponding to virtual channel 427, and a third MMR corresponding to virtual channel 428. The virtual channel MMRs are representative of registers that signify which virtual channel currently has access to secondary DMA channel 429. For example, if the MMR corresponding to virtual channel 426 is enabled, then secondary DMA channel 429 is configured to serve as virtual channel 426. Alternatively, if the MMR corresponding to virtual channel 426 is disabled, then secondary DMA channel 429 is available to serve as either virtual channel 427 or virtual channel 428. In an implementation, channel mask logic 433 and shared channel controller 434 reference the virtual channel MMRs to verify that data is routed to the intended destination.

Channel mask logic 433 is representative of a logical component that ensures data is traversing across the correct virtual channel. For example, channel mask logic 433 may depict hardware, software, firmware, or a combination thereof that verifies whether secondary DMA channel 429 is serving as the appropriate virtual channel for servicing a transfer request. In an implementation, channel mask logic 433 provides a logical link between FIFO buffer 430 and the active virtual channel. For example, if the MMR corresponding to virtual channel 427 is enabled, then channel mask logic 433 may ensure that the data stored by FIFO buffer 430 is intended for peripheral 451.

Shared channel controller 434 is representative of circuitry that ensures data is routed to the desired peripheral. For example, shared channel controller 434 may depict a CPU, MCU, ASIC, or another GPP of the like that verifies whether secondary DMA channel 419 is routing data to the peripheral that was designated by the transfer request. In an implementation, channel mask logic 433 and shared channel controller 434 operate in tandem to ensure a transfer request is properly serviced.

LLDMA circuitry 435 is also representative of the secondary DMA portion (e.g., LLDMA circuitry 107) of a split DMA controller. For example, LLDMA circuitry 435 may depict hardware, software, firmware, or a combination thereof that is capable of interfacing with a corresponding low-latency peripheral group (i.e., peripheral group 453). LLDMA circuitry 435 includes, but is not limited to, secondary DMA channels 436, 437, and 438, FIFO buffer 439, configuration registers 440, 441, and 442, and LLDMA registers 443.

Secondary DMA channels 436, 437, and 438, are representative of channels that transfer data to and from a respective low-latency peripheral. For example, secondary DMA channels 436, 437, and 438 may depict hardware, software, firmware, or a combination thereof that respectively transfer small amounts of data to and from peripherals 454, 455, and 456. In an implementation, secondary DMA channels 436, 437, and 438 are associated with FIFO buffer 439 and respectively associated with configuration registers 440, 441, and 442.

FIFO buffer 439 is representative of local memory that stores transmission data for LLDMA circuitry 435. For example, FIFO buffer 439 may depict a low-latency memory that stores transmission data for secondary DMA channels 436, 437, and 438. In an implementation, FIFO buffer 439 is housed by an on-chip memory. For example, LLDMA circuitry 435 may include cache memory, SRAM, DRAM, or another on-chip memory of the like that stores FIFO buffer 439. In another implementation, FIFO buffer 439 is housed by an off-chip memory. For example, FIFO buffer 439 may be stored by an associated external memory (e.g., memory 120). In either case, FIFO buffer 439 depicts a local memory that enables LLDMA circuitry 435 to transfer data across secondary DMA channels 436, 437, and 438. It should be noted that LLDMA circuitry 435 is not limited to FIFO buffer 439. For example, LLDMA circuitry 435 may include a FIFO buffer for each of its secondary DMA channels, but for the purposes of explanation, FIFO buffer 439 will be discussed herein. This specification is not meant to limit the applications of LLDMA circuitry 435, but rather, to provide an example.

Configuration registers 440, 441, and 442 represent registers that allow system 400 to temporarily pair a respective secondary DMA channel to the appropriate primary DMA channel. For example, configuration registers 440, 441, and 442 may each be configured to store the channel ID of primary DMA channels 402, 403, or 404. In an implementation, when instructed by state machine 412, shared channel mapper 411 writes to, or removes data from configuration registers 440, 441, and 442.

LLDMA registers 443 are representative of registers that store information related to LLDMA circuitry 435. For example, LLDMA registers 443 may store the channel IDs (e.g., thread ID) of secondary DMA channels 436, 437, and 438, the number of available credits within FIFO buffer 439, the amount of available space within FIFO buffer 439, and the width of bus 444. In an implementation, state machine 412 references LLDMA registers 443 to service various transfer requests. For example, if state machine 412 is requested to pair primary DMA channel 403 to secondary DMA channel 438, then state machine 412 may instruct shared channel mapper 411 to access the data stored by LLDMA registers 443 to determine if FIFO buffer 439 has enough room for servicing the transfer request.

Bus 444 is representative of circuitry (e.g., bus 112) that facilitates the transmission of data between the secondary DMA portion of a split DMA controller and various low-latency peripherals. For example, bus 444 may transfer data between LLDMA circuitry 415 and peripheral group 445, LLDMA circuitry 425 and peripheral group 449, and LLDMA circuitry 435 and peripheral group 453. It should be noted that LLDMA circuitries 415, 425, and 435 may each be coupled to a distinct data bus, but for the purposes of explanation, bus 444 will be explained herein. In an implementation, bus 444 depicts a bidirectional bus that is capable of transferring small amounts of data. For example, the width of bus 444 may be equal to 8-bits, 16-bits, or 32-bits. As such, bus 444 is well-suited for transferring data between LLDMA circuitries 415, 425, and 435 and the low-latency peripherals of peripheral groups 445, 449, and 453.

Peripheral groups 445, 449, and 453 each represent a collection of low-latency devices (e.g., peripheral group 113), such that peripheral group 445 includes peripherals 446, 447, and 448, peripheral group 449 includes peripherals 450, 451, and 452, and peripheral group 453 includes peripherals 454, 455, and 456. Peripherals 446, 447, 448, 450, 451, 452, 454, 455, and 456 represent low-latency devices, such as I/O devices, sensors, communication devices/interfaces (e.g., SPI, I2C, UART), or another low-latency peripheral of the like. In an implementation, the peripherals of system 400 are formed into various groups based on a shared communication protocol, clock speed, or the activity of the peripherals. For example, peripheral group 445 may include multiple SPI peripherals, multiple peripherals that operate at the same clock speed, or multiple peripherals that operate out-of-phase with each other.

In an implementation, peripherals 446, 447, 448, 450, 451, 452, 454, 455, and 456 are each mapped to a corresponding DMA channel. More specifically, peripheral 446 corresponds to virtual channel 416 via secondary DMA channel 419, peripheral 447 corresponds to virtual channel 417 via secondary DMA channel 419, peripheral 448 corresponds to virtual channel 418 via secondary DMA channel 419, peripheral 450 corresponds to virtual channel 426 via secondary DMA channel 429, peripheral 451 corresponds to virtual channel 427 via secondary DMA channel 429, peripheral 452 corresponds to virtual channel 428 via secondary DMA channel 429, peripheral 454 corresponds to secondary DMA channel 436, peripheral 455 corresponds to secondary DMA channel 437, and peripheral 456 corresponds to secondary DMA channel 438. Accordingly, each peripheral of peripheral groups 445, 449, and 453 may transmit data to or receive data from an external memory via the respective secondary DMA channel.

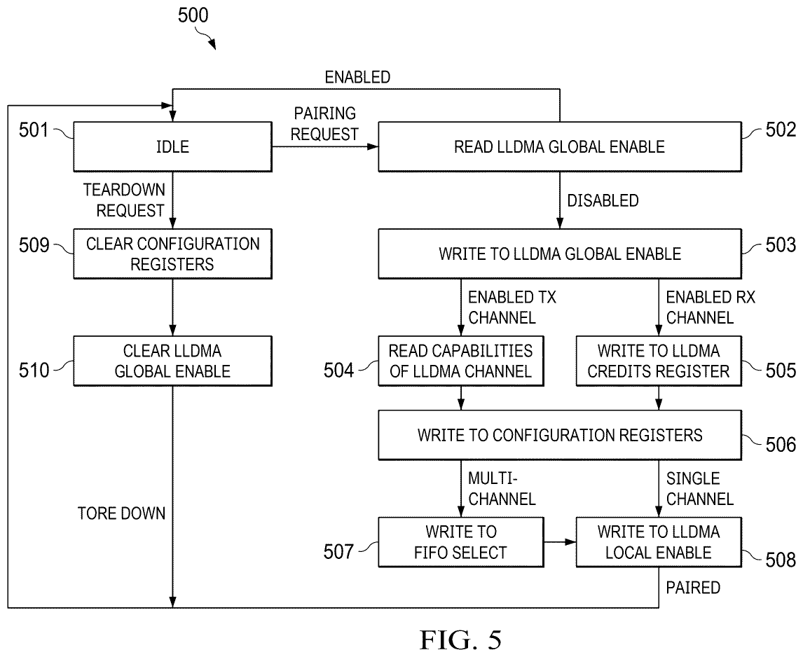

FIG. 5 illustrates state machine diagram 500 in an implementation. State machine diagram 500 provides a visualization for the logic that is employed by a state machine of a split DMA controller as presented herein. For example, state machine diagram 500 may provide a visualization for the logic that is employed by either state machine 105 of FIG. 1 or state machine 412 of FIG. 4. For the purposes of explanation, state machine diagram 500 will be explained with the elements of FIG. 4. This specification is not meant to limit the applications of state machine diagram 500, but rather to provide an example.

To begin, state machine 412 starts within idle state 501. Idle state 501 describes the operative mode for when state machine 412 is awaiting to receive a DMA request from the associated CPU. For example, when operating under idle state 501, state machine 412 may observe MMRs 413 to determine when the associated CPU has issued a transfer request or a teardown request.

In an implementation, if the associated CPU enables an MMR corresponding to a primary DMA channel servicing a specific peripheral, then state machine 412 is triggered to service a transfer request. For example, the associated CPU may write an enable value to the MMR corresponding to primary DMA channel 403 servicing peripheral 448, and in response, state machine 412 transitions to read state 502.

Read state 502 describes the operative mode for when state machine 412 determines if the secondary DMA channel is available for servicing the transfer request. In an implementation, when operating under read state 502, state machine 412 first identifies the secondary DMA channel for servicing the transfer request. For example, if the associated CPU enabled the MMR corresponding to primary DMA channel 403 servicing peripheral 448, then state machine 412 identifies secondary DMA channel 419 as the secondary DMA channel for servicing the transfer request. Once identified, state machine 412 checks MMRs 413 to determine if the MMR corresponding to secondary DMA channel 419 stores an enable value or a disable value. For example, state machine 412 may instruct shared channel mapper 411 to read the data stored by the MMR corresponding to secondary DMA channel 419. If enabled, state machine 412 determines that secondary DMA channel 419 is unavailable, and returns to idle state 501. Alternatively, if disabled, state machine 412 transitions to write state 503.

Write state 503 describes the operative mode for when state machine 412 enables the secondary DMA channel for servicing the transfer request. For example, if state machine 412 identifies secondary DMA channel 419 as the secondary DMA channel for servicing the transfer request, then state machine 412 may, when operating under write state 503, instruct shared channel mapper 411 to write an enable value to the MMR of MMRs 413 that corresponds to secondary DMA channel 419. Once enabled, state machine 412 determines if the transfer request corresponds to a transmit request or a receive request. A transmit request refers to a request for data to be transmitted from an external memory. Alternatively, a receive request refers to a request for data to be received by an external memory.

In an implementation, if state machine 412 determines that the transfer request corresponds to a transmit request, then, state machine 412 transitions to read state 504. Read state 504 describes the operative mode for when state machine 412 determines if the corresponding FIFO buffer includes enough space for accommodating the transmit request. For example, state machine 412 may instruct shared channel mapper 411 to evaluate LLDMA registers 422 to determine whether FIFO buffer 420 includes enough space to service the transmit request. If sufficient, state machine 412 transitions to write state 506. Otherwise, state machine 412 remains in read state 504 until enough space becomes available within FIFO buffer 420.

In another implementation, if state machine 412 determines that the transfer request corresponds to a receive request, then, state machine 412 transitions to write state 505. Write state 505 describes the operative mode for when state machine 412 updates the number of available credits within the corresponding FIFO buffer. For example, state machine 412 may instruct shared channel mapper 411 to write to LLDMA registers 422 to decrement the number of available credits within FIFO buffer 420. Once written, state machine 412 transitions to write state 506.

Write state 506 describes the operative mode for when state machine 412 pairs the DMA channels for servicing the transfer request. In an implementation, to pair the DMA channels for servicing the transfer request, state machine 412 instructs shared channel mapper 411 to write the channel IDs of said channels to the corresponding configuration registers. For example, state machine 412 may instruct shared channel mapper 411 to write the thread ID of secondary DMA channel 419 to configuration register 409. State machine 412 may then instruct shared channel mapper 411 to utilize a dedicated path within CPS 414 to write the thread ID of primary DMA channel 403 to configuration register 421. As a result, state machine 412 causes shared channel mapper 411 to enable the path in CPS 414 that connects primary DMA channel 403 to secondary DMA channel 419. Once enabled, state machine 412 determines if secondary DMA channel 419 supports one or more virtual channels and if so, if the peripheral associated with the transfer request corresponds to one of the virtual channels.

In an implementation, if state machine 412 determines that the peripheral associated with the transfer request corresponds to a virtual channel, then, state machine 412 transitions to write state 507. Write state 507 describes the operative mode for when state machine 412 enables the appropriate virtual channel for servicing the transfer request. For example, if the associated CPU requested for data to be transferred to peripheral 448, then state machine 412 may determine that peripheral 448 is associated with virtual channel 418. Once determined, state machine 412 may then instruct shared channel mapper 411 to write an enable value to the MMR corresponding to virtual channel 418. For example, shared channel mapper 411 may utilize a dedicated path within CPS 414 to write an enable bit to the appropriate MMR within LLDMA registers 422. As a result, shared channel mapper 411 causes secondary DMA channel 419 to serve as virtual channel 418 and state machine 412 transitions to write state 508.

In another implementation, if state machine 412 determines that the peripheral associated with the transfer request does not correspond to a virtual channel, then, state machine 412 transitions to write state 508. For example, if the associated CPU requested for data to be transferred to peripheral 456, then state machine 412 may determine that peripheral 456 is not associated with a virtual channel and is instead associated with secondary DMA channel 438. Once determined, state machine 412 may then transition to write state 508.

Write state 508 describes the operative mode for when state machine 412 issues the instruction to service the transfer request. For example, when operating under write state 508, state machine 412 may enable a register within LLDMA registers 422 that causes LLDMA circuitry 415 and primary DMA circuitry 401 to perform the operations for servicing the transfer request. Meaning, state machine 412 instructs primary DMA circuitry 401 and LLDMA circuitry 415 to utilize primary DMA channel 403 and FIFO buffer 407, as well as secondary DMA channel 419 (currently serving as virtual channel 418) and FIFO buffer 420 to route data between the external memory and peripheral 448. Once instructed, state machine 412 returns to idle state 501.

In another implementation, if the associated CPU writes a disable value to an MMR corresponding to a primary DMA channel servicing a specific peripheral, then state machine 412 is triggered to service a teardown request. For example, the associated CPU may write a disable value to the MMR corresponding to primary DMA channel 403 servicing peripheral 448, thereby causing state machine 412 to transition to clear state 508.

Clear state 508 describes the operative mode for when state machine 412 disables a path within CPS 414 that was previously enabled. For example, when operating under clear state 508, state machine 412 may disable the path within CPS 414 that connects primary DMA channel 403 to secondary DMA channel 419. In an implementation, to disable a path within CPS 414 that connects a primary DMA channel to a secondary DMA channel, state machine 412 instructs shared channel mapper 411 to remove the channel IDs from the corresponding configuration registers. For example, state machine 412 may instruct shared channel mapper 411 to remove the thread ID of secondary DMA channel 419 from configuration register 409. State machine 412 may then instruct shared channel mapper 411 to utilize a dedicated path within CPS 414 to remove the thread ID of primary DMA channel 403 from configuration register 421. As a result, shared channel mapper 411 disables the path in CPS 414 that connects primary DMA channel 403 to secondary DMA channel 419. Once disabled, state machine 412 then instructs shared channel mapper 411 to write a disable value to the MMR corresponding to virtual channel 419. For example, state machine 412 may then instruct shared channel mapper 411 to utilize a dedicated path within CPS 414 to write a disable bit to the MMR corresponding to virtual channel 419. As a result, shared channel mapper 411 makes secondary DMA channel 419 available to serve as another virtual channel. Once available, state machine 412 transitions to clear state 509.

Clear state 509 describes the operative mode for when state machine 412 writes a disable value to the MMR corresponding to a secondary DMA channel, thereby signifying that the channel is available to service additional transfer requests. For example, when operating under clear state 509, state machine 412 may instruct shared channel mapper 411 to write a disable value to the MMR within MMRs 413 that corresponds to secondary DMA channel 419, thereby making secondary DMA channel 419 available to service subsequent transfer requests. Once disabled, state machine 412 returns to idle state 501.

Advantageously, state machine diagram 500 provides a technique for servicing transfer requests within the context of a split DMA controller that employs virtual channels.

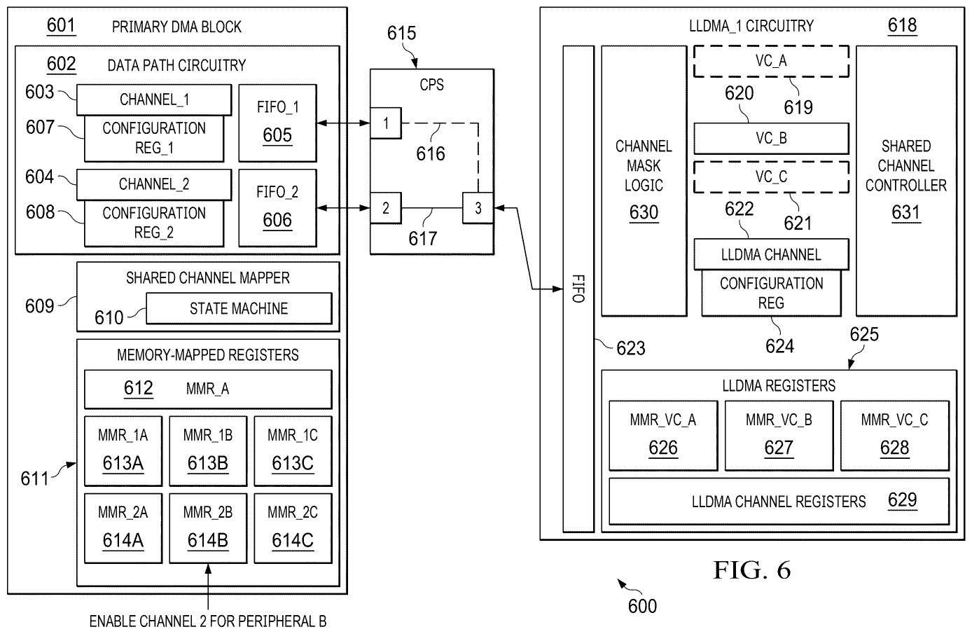

FIG. 6 illustrates operational scenario 600 in an implementation. Operational scenario 600 is representative of a scenario for servicing a transfer request with respect to a split DMA controller that employs virtual channels. For example, operational scenario 600 may provide a scenario for servicing a transfer request within the context of system 100 or system 400. Operational scenario 600 includes primary DMA block 601, CPS 615, and LLDMA circuitry 618.

Primary DMA block 601 represents the high-latency portion of a split DMA controller. For example, primary DMA block 601 may be representative of DMA circuitry 101 of FIG. 1 or primary DMA circuitry 401 of FIG. 4. Primary DMA block 601 includes, but is not limited to, data path circuitry 602, shared channel mapper 609, and MMRs 611.

Data path circuitry 602 is representative of circuitry that is capable of interfacing with an external memory. For example, data path circuitry 602 may depict circuitry capable of interfacing with a high-latency memory, such as flash memory. Data path circuitry 602 includes, but is not limited to, primary DMA channels 603 and 604, FIFO buffers 605 and 606, and configuration registers 607 and 608.

Primary DMA channels 603 and 604 represent channels that transfer data to and from an external memory. For example, primary DMA channels 603 and 604 may be representative of primary DMA channels 102, 103, and 104 of FIG. 1, or primary DMA channels 402, 403, and 404 of FIG. 4. In an implementation, each primary DMA channel of data path circuitry 602 is associated with a respective FIFO buffer and a configuration register. For example, primary DMA channel 603 may be associated with FIFO buffer 605 and configuration register 607, while primary DMA channel 604 may be associated with FIFO buffer 606 and configuration register 608.

FIFO buffers 605 and 606 are representative of local memories that store transmission data for a respective primary DMA channel. For example, FIFO buffers 605 and 606 may depict high-latency memories that respectively store transmission data for primary DMA channels 603 and 604. In an implementation, FIFO buffers 605 and 606 are housed by an on-chip memory. For example, data path circuitry 602 may include cache memory, SRAM, DRAM, or another on-chip memory of the like that stores FIFO buffers 605 and 606. In another implementation, FIFO buffers 605 and 606 are housed by an off-chip memory. For example, FIFO buffers 605 and 606 may be stored by an associated flash memory (e.g., memory 120). In either case, FIFO buffers 605 and 606 depict local memories that enable data path circuitry 602 to respectively transfer data across primary DMA channels 603 and 604.

Configuration registers 607 and 608 are representative of registers that allow a respective primary DMA channel to be paired to the appropriate secondary DMA channel. For example, configuration registers 607 and 608 may each be configured to store the channel ID of secondary DMA channel 622. More specifically, configuration registers 607 and 608 may store the thread ID of secondary DMA channel 622. In an implementation, configuration registers 607 and 608 are populated by shared channel mapper 609.

Shared channel mapper 609 is representative of circuitry (e.g., shared channel mapper 411) that controls the operations of primary DMA block 601. For example, shared channel mapper 609 may depict a CPU, MCU, ASIC, or another GPP of the like that manages the operations required for servicing a transfer request. Shared channel mapper 609 includes state machine 610.

State machine 610 is representative of a hardware state machine that enables the pathways for servicing a transfer request. For example, state machine 610 may depict state machine 105 of FIG. 1 or state machine 412 of FIG. 4. In an implementation, state machine 610 receives transfer requests from an associated CPU, and in response, pairs the DMA channels for servicing the transfer request. For example, the associated CPU may request state machine 610 to establish the connections for transferring data between a high-latency memory and various low-latency peripherals. In an implementation, state machine 610 receives transfer requests via MMRs 611.

MMRs 611 are representative of registers that indicate whether a respective DMA channel is available for transferring data to or from a specific peripheral. For example, MMRs 611 may be representative of MMRs 413 of FIG. 4. MMRs 611 includes secondary MMRs 612, primary MMRs 613A, 613B, and 613C, and primary MMRs 614A, 614B, and 614C.

Secondary MMR 612 is representative of a register that indicates whether secondary DMA channel 622 is currently available. For example, secondary MMR 612 may indicate whether secondary DMA channel 622 is currently available to transfer data to or from an associated peripheral. In an implementation, if secondary MMR 612 is disabled, then secondary DMA channel 622 is available to transfer data. Alternatively, if secondary MMR 612 is enabled, then secondary DMA channel 622 is unavailable to transfer data. More specifically, secondary DMA channel 622 is occupied servicing a transfer request. In an implementation, secondary MMR 612 is enabled or disabled by shared channel mapper 609.

Primary MMRs 613A-613C and primary MMRs 614A-614C are representative of registers that indicate whether a respective primary DMA channel is currently available to transfer data to or from a specific peripheral. For example, primary MMR 613A may indicate whether primary DMA channel 603 is currently available to transfer data to or from the peripheral that is associated with virtual channel 619, primary MMR 613B may indicate whether primary DMA channel 603 is currently available to transfer data to or from the peripheral that is associated with virtual channel 620, and primary MMR 613C may indicate whether primary DMA channel 603 is currently available to transfer data to or from the peripheral that is associated with virtual channel 621. Meanwhile, primary MMR 614A may indicate whether primary DMA channel 604 is currently available to transfer data to or from the peripheral that is associated with virtual channel 619, primary MMR 614B may indicate whether primary DMA channel 604 is currently available to transfer data to or from the peripheral that is associated with virtual channel 620, and primary MMR 614C may indicate whether primary DMA channel 604 is currently available to transfer data to or from the peripheral that is associated with virtual channel 621.

In an implementation, if a primary MMR is disabled, then the corresponding DMA channel is available to transfer data. For example, if primary MMR 613A is disabled, then primary DMA channel 603 is available to transfer data to or from the peripheral that is associated with virtual channel 619. Alternatively, if a primary MMR is enabled, then the corresponding DMA channel is unavailable to transfer data. More specifically, the corresponding DMA channel is occupied servicing a transfer request. For example, if primary MMR 613A is enabled, then primary DMA channel 603 is currently occupied transferring data to or from the peripheral that is associated with virtual channel 619. In an implementation, primary MMRs 613A-613C and primary MMRs 614A-614C are enabled or disabled by an associated CPU. For example, the associated CPU may supply transfer requests to state machine 610 via primary MMRs 613A-613D and primary MMRs 614A-614D.

CPS 615 is representative of circuitry (e.g., CPS 106 and CPS 414) that includes pathways for connecting the primary DMA channels of data path circuitry 602 to the secondary DMA channel of LLDMA circuitry 618. For example, CPS 615 may depict a crossbar switch that includes pathways for connecting the FIFO buffers associated with the primary DMA channels to the FIFO buffer associated with the secondary DMA channel. In an implementation, CPS 615 also includes dedicated pathways (not shown) that allow state machine 610 to pair secondary DMA channel 622 to primary DMA channels 603 and 604, as well as dedicated pathways that allow state machine 610 to enable a virtual channel. As such, CPS 615 includes, but is not limited to, paths 616 and 617.

Paths 616 and 617 are representative of logical connections that allow for the exchange of data between data path circuitry 602 and LLDMA circuitry 618. More specifically, path 616 is representative of connection that allows primary DMA channel 603 to exchange data with secondary DMA channel 622, and in turn virtual channels 619, 620, and 621. Meanwhile, path 617 is representative of connection that allows primary DMA channel 604 to exchange data with secondary DMA channel 622, and in turn virtual channels 619, 620, and 621. In an implementation, paths 616 and 617 are enabled and disabled by state machine 610.

LLDMA circuitry 618 represents the low-latency portion of a split DMA controller. For example, LLDMA circuitry 618 may be representative of LLDMA circuitry 107 of FIG. 1 or LLDMA circuitries 415 and 425 of FIG. 4. LLDMA circuitry 618 includes, but is not limited to, virtual channels 619, 620, and 621, secondary DMA channel 622, FIFO buffer 623, configuration register 624, LLDMA registers 625, channel mask logic 630, and shared channel controller 631.

Virtual channels 619, 620, and 621 represent a set of logically defined DMA channels (e.g., virtual channels 108-110, 416-418, or 426-428) that are implemented via the hardware of secondary DMA channel 622. As such, virtual channels 619, 620, and 621 serve as secondary DMA channels that exchange data with a respective low-latency peripheral.

Secondary DMA channel 622 is representative of a DMA channel (e.g., secondary DMA channel 111, 419, 429, 436, 437, or 438) that provides the underlying mechanism for exchanging data via a virtual channel. For example, secondary DMA channel 622 may depict hardware, software, firmware, or a combination thereof that transfers small amounts of data to and from the peripherals which correspond to virtual channels 619, 620, and 621. In an implementation, secondary DMA channel 622 is associated with FIFO buffer 623 and configuration register 624.

FIFO buffer 623 is representative of a local memory that stores transmission data for LLDMA circuitry 618. For example, FIFO buffer 623 may depict a low-latency memory that stores transmission data for secondary DMA channel 622, and in turn, virtual channels 619, 620, and 621. In an implementation, FIFO buffer 623 is housed by an on-chip memory. For example, LLDMA circuitry 618 may include cache memory, SRAM, DRAM, or another on-chip memory of the like that stores FIFO buffer 623. In another implementation, FIFO buffer 623 is housed by an off-chip memory. For example, FIFO buffer 623 may be stored by an associated external memory (e.g., memory 120). In either case, FIFO buffer 623 depicts a local memory that enables LLDMA circuitry 618 to transfer data across secondary DMA channel 622. It should be noted that LLDMA circuitry 618 is not limited to FIFO buffer 623. For example, LLDMA circuitry 618 may include a FIFO buffer for each of its virtual channels, but for the purposes of explanation, FIFO buffer 623 will be discussed herein. This specification is not meant to limit the applications of LLDMA circuitry 618, but rather, to provide an example.

Configuration register 624 represents a register that allows state machine 610 to temporarily pair secondary DMA channel 622 to the appropriate primary DMA channel. For example, configuration register 624 may be configured to store the channel ID of primary DMA channels 603 or 604. In an implementation, when instructed by state machine 610, shared channel mapper 609 writes to, or removes data from configuration register 624.

LLDMA registers 625 are representative of a set of registers that store information related to LLDMA circuitry 618. For example, LLDMA registers 625 may store data related to virtual channels 619, 620, and 621, secondary DMA channel 622, and FIFO buffer 623. LLDMA registers 625 include, but are not limited to, MMRs 626, 627, and 628, and LLDMA channel registers 629.

LLDMA channel registers 629 are representative of registers that store data related to secondary DMA channel 622 and FIFO buffer 623. For example, LLDMA channel register 629 may store the channel ID (e.g., thread ID) of secondary DMA channel 622, the number of available credits within FIFO buffer 623, the amount of available space within FIFO buffer 623, and the width of an associated bus. In an implementation, state machine 610 references LLDMA channel registers 629 to service various transfer requests. For example, if state machine 610 is requested to pair primary DMA channel 603 to secondary DMA channel 622, then state machine 610 may instruct shared channel mapper 609 to access the data stored by LLDMA channel registers 629 to determine if FIFO buffer 623 has enough room for servicing the transfer request.

MMRs 626, 627, and 628 are representative of virtual channel registers that respectively signify which of virtual channels 619, 620, and 621 currently has access to secondary DMA channel 622. In an implementation, if a virtual channel register is enabled, then secondary DMA channel 622 is configured to serve as the corresponding virtual channel. For example, if MMR 626 is enabled, then secondary DMA channel 622 is configured to serve as virtual channel 619. Alternatively, if a virtual channel register is disabled, then secondary DMA channel 622 is available to serve as another virtual channel. In an implementation, channel mask logic 630 and shared channel controller 631 reference MMRs 626, 627, and 628 to verify that data is routed to the intended destination.

Channel mask logic 630 is representative of a logical component that ensures data is traversing across the correct virtual channel. For example, channel mask logic 630 may depict channel mask logic 423 of FIG. 4. In an implementation, channel mask logic 630 provides a logical link between FIFO buffer 623 and the active virtual channel. For example, if MMR 626 is enabled, then channel mask logic 630 may ensure that the data stored by FIFO buffer 623 is intended for the peripheral corresponding to virtual channel 619.

Shared channel controller 631 is representative of circuitry that ensures data is routed to the desired peripheral. For example, shared channel controller 631 may depict shared channel controller 424 of FIG. 4. In an implementation, channel mask logic 630 and shared channel controller 631 operate in tandem to ensure a transfer request is properly serviced.

To begin operational scenario 600, an associated CPU enables primary MMR 614B. In response, state machine 610 determines that the associated CPU wishes to transfer data from an external memory to the peripheral associated with virtual channel 620. Next, state machine 610 determines if secondary DMA channel 622 is available for servicing the transfer request. For example, state machine 610 may instruct shared channel mapper 609 to read-out the data stored by secondary MMR 612, and resultingly determine that MMR 612 is currently disabled. As such, state machine 610 determines that secondary DMA channel 622 is currently available for servicing the transfer request and responsively instructs shared channel mapper 609 to enable secondary MMR 612.

Next, state machine 610 classifies the transfer request as a transmit request, and in response, instructs shared channel mapper 609 to check LLDMA registers 629 to determine that FIFO buffer 623 includes enough space for servicing the request. Once determined, state machine 610 enables the path in CPS 615 that connects primary DMA channel 604 to secondary DMA channel 622. For example, state machine 610 may instruct shared channel mapper 609 to write the thread ID of secondary DMA channel 622 to configuration register 608. State machine 610 may then instruct shared channel mapper 609 to utilize a dedicated path (not shown) in CPS 615 to write the thread ID of primary DMA channel 604 to configuration register 624. As a result, shared channel mapper 609 enables path 617, thereby connecting FIFO buffer 606 to FIFO buffer 623.

Once enabled, state machine 610 responsively enables the appropriate virtual channel for servicing the transfer request. For example, state machine 610 may instruct shared channel mapper 609 to utilize a dedicated path (not shown) in CPS 615 to write an enable bit to MMR 627. As a result, shared channel mapper 609 configures secondary DMA channel 622 to serve as virtual channel 620.

Next, state machine 610 instructs data path circuitry 602 to transfer the requested data from primary DMA channel 604 to secondary DMA channel 622 via path 617. More specifically, state machine 610 instructs data path circuitry 602 to transfer the requested data from FIFO buffer 606 to FIFO buffer 623 via path 617. In response, channel mask logic 630 determines that the data currently stored by FIFO buffer 623 corresponds to the peripheral associated with virtual channel 620. Channel mask logic 630 then determines that secondary DMA channel 622 is configured as the appropriate virtual channel (i.e., virtual channel 620). Once determined, channel mask logic 630 applies a mask to the data which causes LLDMA circuitry 618 to transmit the data from secondary DMA channel 622 serving as virtual channel 620 to the intended peripheral, such that shared channel controller 631 ensures that the data is transmitted to the intended peripheral.

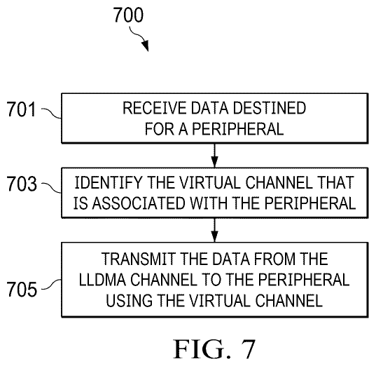

FIG. 7 illustrates method 700 in an implementation. Method 700 is representative of a technique for servicing a transfer request with respect to the secondary portion of a split DMA controller that employs virtual channels. Method 700 may be implemented in the context of hardware, firmware, or software to cause a system to operate as follows, referring parenthetically to the steps in FIG. 7. For the purposes of explanation, method 700 will be explained with respect to the elements of FIG. 4. This is not meant to limit the applications of method 700, but rather to provide an example for purposes of illustration.

To begin, FIFO buffer 430 is supplied with data destined for peripheral 450 (step 701). For example, primary DMA circuitry 401 may transmit data from FIFO buffer 406 to FIFO buffer 430 via an enabled path within CPS 414. In response, channel mask logic 433 identifies which virtual channel is associated with peripheral 450 (step 703). For example, channel mask logic 433 may check LLDMA registers 432 and determine that the MMR corresponding to virtual channel 426 is enabled.

Next, channel mask logic 433 verifies that the data currently stored by FIFO buffer 430 is intended for peripheral 450. Once verified, channel mask logic 433 applies a mask to the data which causes LLDMA circuitry 425 to transmit the data from secondary DMA channel 429 serving as virtual channel 427 to peripheral 450 (step 705). During transmission, shared channel controller 434 ensures the data is transmitted to peripheral 450. For example, shared channel controller 434 may ensure that LLDMA circuitry 425 uses the appropriate path within bus 444 to transmit the data to peripheral 450.

Advantageously, method 700 provides a technique for servicing transfer requests within the context of a split DMA controller that reduces the number of dedicated secondary DMA channels. Instead, method 700 leverages virtual channels to manage the exchange of data between a high-latency memory and various low-latency peripherals. As a result, method 700 is particularly well-suited for resource-constrained environments, such as embedded systems or low-power applications, where minimizing area, reducing system cost, and conserving energy are critical design goals.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

Circuits described herein are reconfigurable to include additional or different components to provide functionality at least partially similar to functionality available prior to the component replacement.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Modifications are possible in the described embodiments, and other embodiments are possible, within the scope of the claims.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A direct memory access (DMA) controller comprising:
a set of primary DMA channel circuits coupled to a first set of devices;
a set of secondary DMA channel circuits coupled to a second set of devices;
a packet switch coupled to the primary DMA channel circuits and the secondary DMA channel circuits; and
a state machine coupled to the packet switch, wherein the state machine is operable to:
receive a request to transmit data via a first channel circuit of the primary DMA channel circuits to a device of the second set of devices associated with a second channel circuit of the secondary DMA channel circuits; and
in response to the request:
determine that the second channel circuit is available and responsively pair the first channel circuit with the second channel circuit;
enable a virtual channel that is associated with the device and the second channel circuit;
instruct the first channel circuit to transmit the data via the packet switch to the second channel circuit; and
cause the second channel circuit to write the data to the device using the virtual channel.

2. The DMA controller of claim 1, wherein to determine that the second channel circuit is available, the state machine is operable to determine that one or more other virtual channels associated with the second channel circuit are disabled.

3. The DMA controller of claim 2, wherein in response to the request, the state machine is operable to determine that the second channel circuit is unavailable and responsively output a fault indicator, and wherein to determine that the second channel circuit is unavailable, the state machine is operable to determine that one of the one or more other virtual channels associated with the second channel circuit is enabled.

4. The DMA controller of claim 1, wherein to enable the virtual channel, the state machine is operable to write an enable value to a memory-mapped register associated with the virtual channel.

5. The DMA controller of claim 4, wherein to pair the first channel circuit with the second channel circuit, the state machine is operable to:
write a channel identifier (ID) of the second channel circuit to a configuration register associated with the first channel circuit; and
write a channel ID of the first channel circuit to a configuration register associated with the second channel circuit.

6. The DMA controller of claim 5, wherein the packet switch is operable to route the data from the first channel circuit to the second channel circuit via a path which couples the first channel circuit to the second channel circuit.

7. The DMA controller of claim 6, wherein the state machine is further operable to receive a second request to disable the path which couples the first channel circuit to the second channel circuit, and in response to the second request:
remove the channel ID of the second channel circuit from the configuration register associated with the first channel circuit;
remove the channel ID of the first channel circuit from the configuration register associated with the second channel circuit; and
write a disable value to the memory-mapped register associated with virtual channel.

8. The DMA controller of claim 1, wherein the DMA controller further includes channel mask logic operable to ensure that the enabled virtual channel is associated with the second channel circuit, and a shared channel controller operable to ensure that the data is transmitted from the second channel circuit to the device.

9. The DMA controller of claim 1, wherein a latency associated with each of the first set of devices is greater than a latency associated with each of the second set of devices, and wherein the state machine includes a hardware state machine.

10. A direct memory access (DMA) controller comprising:
data path circuitry including a set of primary DMA channel circuits operable to couple to a memory; and
state machine circuitry coupled to the data path circuitry, wherein the state machine circuitry is operable to:
receive a request to transmit data via a first channel circuit of the primary DMA channel circuits to a device associated with a second channel circuit of a set of secondary DMA channel circuits; and
in response to the request:
determine that the second channel circuit is available and responsively pair the first channel circuit with the second channel circuit;
enable a virtual channel that is associated with the device and the second channel circuit;
instruct the data path circuitry to transmit the data from the first channel circuit to the second channel circuit; and
cause the second channel circuit to write the data to the device using the virtual channel.

11. The DMA controller of claim 10, wherein to determine that the second channel circuit is available, the state machine circuitry is operable to determine that one or more other virtual channels associated with the second channel circuit are disabled.

12. The DMA controller of claim 11, wherein in response to the request, the state machine circuitry is operable to determine that the second channel circuit is unavailable and responsively output a fault indicator, and wherein to determine that the second channel circuit is unavailable, the state machine circuitry is operable to determine that one of the one or more other virtual channels associated with the second channel circuit is enabled.

13. The DMA controller of claim 10, wherein to enable the virtual channel, the state machine circuitry is operable to write an enable value to a memory-mapped register associated with the virtual channel.

14. The DMA controller of claim 13, wherein to pair the first channel circuit with the second channel circuit, the state machine circuitry is operable to:
write a channel identifier (ID) of the second channel circuit to a configuration register associated with the first channel circuit; and
write a channel ID of the first channel circuit to a configuration register associated with the second channel circuit.

15. The DMA controller of claim 14, wherein to transmit the data from the first channel circuit to the second channel circuit, the data path circuitry is operable to route the data from the first channel circuit to the second channel circuit via a path of an associated packet switch which couples the first channel circuit to the second channel circuit.

16. The DMA controller of claim 15, wherein the state machine circuitry is further operable to receive a second request to disable the path which couples the first channel circuit to the second channel circuit, and in response to the second request:
remove the channel ID of the second channel circuit from the configuration register associated with the first channel circuit;
remove the channel ID of the first channel circuit from the configuration register associated with the second channel circuit; and
write a disable value to the memory-mapped register associated with virtual channel.

17. The DMA controller of claim 10, wherein a latency associated with the memory is greater than a latency associated with the device, and wherein the state machine circuitry includes a hardware state machine.

18. A non-transitory computer-readable medium having program instructions stored thereon, configured to be executable by processing circuitry, wherein the program instructions, when executed by the processing circuitry, cause the processing circuitry to cause direct memory access (DMA) circuitry that includes primary DMA circuitry, secondary DMA circuitry, and a packet switch coupled between the primary DMA circuitry and the secondary DMA circuitry to:
identify a first DMA channel circuit coupled to a first device that stores a set of data;
identify a second DMA channel circuit coupled to a second device capable of receiving the set of data;
enable a communication path between the first DMA channel circuit and the second DMA channel circuit via the packet switch;
enable a virtual channel associated with the second device;
provide the set of data from the first device to the second DMA channel circuit via the first DMA channel circuit and the packet switch; and
provide the set of data from the second DMA channel circuit to the second device using the virtual channel.

19. The non-transitory computer-readable medium of claim 18, wherein the program instructions further cause the processing circuitry to cause the DMA circuitry to determine that the second DMA channel circuit is available, and wherein to determine that the second DMA channel circuit is available, the program instructions further cause the processing circuitry to cause the DMA circuitry to determine that one or more other virtual channels associated with the second DMA channel circuit are disabled.

20. The non-transitory computer-readable medium of claim 18, wherein the program instructions further cause the processing circuitry to cause the DMA circuitry to disable the communication path between the first DMA channel circuit and the second DMA channel circuit and to disable the virtual channel.
